(19) United States
(12) Patent Application Publication
(10) Pub. No.: US 2026/0243389 A1
(43) Pub. Date: Aug. 20, 2026

(54) Corexy Type Motion System

(71) Applicant: Pragostroj s.r.o., Kurim (CZ)

(72) Inventor: Jiri Pribyl, Praha (CZ)

(73) Assignee: Pragostroj s.r.o., Kurim (CZ)

(21) Appl. No.: 19/161,884

(22) PCT Filed: Mar. 1, 2024
(86) PCT No.: PCT/CZ2024/050012

§ 371 Date: Sep. 3, 2025

(30) Foreign Application Priority Data
Mar. 3, 2023 (CZ) PV 2023-85

(51) Int. Cl. F16M 13/00

(52) U.S. Cl. CPC F16M 13/00

(57) ABSTRACT

A CoreXY type motion system comprises a set of carriages, a first system of pulleys, and a second system of pulleys. The set of carriages comprises a central carriage, a supporting carriage, and a basic structure. The central carriage is slidingly movably connected to the supporting carriage in the direction of the X-axis and the supporting carriage is slidingly movably connected to the basic structure in the direction of the Y-axis perpendicular to the X-axis. The first system of pulleys comprises a disc comprising a first drum and the second system of pulleys comprises a disc comprising a second drum. A first cable is pulled through the first system of pulleys, with its ends attached to the central carriage and wrapped around the first drum with at least two wraps. A second cable is pulled through the second system of pulleys, with its ends attached to the central carriage, and wrapped around the second drum with at least two wraps.

### TECHNICAL FIELD

The invention relates to a CoreXY type motion system for providing motion in the horizontal plane, for example for use in 3D printers, CNC machines, scanning devices.

### BACKGROUND OF THE INVENTION

Nowadays, devices with CoreXY motion mechanism are becoming more and more popular because its motors are stationary, wherein they do not increase the mechanical load and momentum of the motion system. Combined with a set of pulleys that mediates the work of the motors to move a central carriage, which is moved in the horizontal plane, the system is also overall well mechanically optimized and exhibits reduced vibrations, wherein it allows for faster motions, even in systems where the directions of motion are frequently changed, such as in 3D printing.

Still, the current solutions exhibit a certain amount of lag when the machine transitions from motion in one direction to motion in the opposite direction, where clearances and deviations in the gears add up, resulting in the creation of various unwanted fragments, such as inaccuracies and plateaus on a printout from a 3D printer implementing such a CoreXY motion system.

Lags during direction change are solved by some systems by software, where these lags are implemented in formulas dictating the motion scheme of such CoreXY motion system. However, such a solution is very expensive, complicates machine control and does not solve the problem completely.

Current solutions usually also use a toothed belt, where the sets of pulleys are formed by toothed discs, wherein due to small deviations between the teeth of the belt and the teeth of the discs, unwanted vibrations and deformations of the belt occur, which also negatively affect the function of the motion system during acceleration/deceleration of the motion system.

Another disadvantage of the current CoreXY system solutions is the fact that some parts of the motion system are made of different materials with different thermal expansion, for example, individual discs versus a belt stretched by a set of pulleys made of these discs, which results in a different level of lag in different operating cycles, when the operating temperature of the system varies over time depending on the set speeds of the motion of the central carriage or, in the case of 3D printers, also depending on, for example, the temperature of the heated pad or extruder. Here, various systems can be implemented to maintain a certain operating temperature, but such solutions significantly complicate the structure of the motion system and increase the cost of its operation.

The current state of the art is represented by the solutions disclosed in the documents CN111872570 A, CN214774013U, and US20180225625 A1.

It follows from the above that it is desirable to develop a motion system providing the motion of the functional component on the central carriage in the horizontal plane that is mechanically optimized, minimizes vibrations in the system, and eliminates the influence of inaccuracies and clearances in the gears, thus ensuring perfectly accurate motion of the functional component on the central carriage even at higher speeds and sudden changes in direction.

### SUMMARY OF THE INVENTION

The above shortcomings are eliminated by a CoreXY type motion system comprising a set of carriages, a first system of pulleys, and a second system of pulleys, wherein the set of carriages comprises a central carriage, a supporting carriage, and a basic structure, wherein the central carriage is slidingly movably connected to the supporting carriage in the direction of the X-axis and the supporting carriage is slidingly movably connected to the basic structure in the direction of the Y-axis perpendicular to the X-axis, the first system of pulleys comprises a first driven disc connected to the basic structure and two discs of the supporting carriage attached to opposite sides of the supporting carriage and the second system of pulleys comprises a second driven disc connected to the basic structure and two discs of the supporting carriage attached to opposite sides of the supporting carriage. The motion system of the invention further comprises a first cable and a second cable, the first system of pulleys comprises a disc comprising a first drum and the second system of pulleys comprises a disc comprising a second drum, wherein the first cable is pulled through the first system of pulleys, attached by its ends to the central carriage and wrapped around the first drum with at least 2 wraps, wherein the second cable is pulled through the second system of pulleys, attached by its ends to the central carriage and wrapped around the second drum with at least 2 wraps.

There is a significant amount of industrial devices where there is a need to ensure the motion of the functional component, such as the print head of a 3D printer, CNC machine, or scanning head of a scanning device in a plane defined by the mutually perpendicular X- and Y-axes, or in a 3D space with added vertical Z-axis, perpendicular to the X- and Y-axes. The CoreXY motion system is a specific implementation of providing the motion of such a functional component in the X- and Y-axes in these motion arrangement systems. The CoreXY motion system is generally characterized by comprising a first belt, a second belt, a first system of pulleys and a second system of pulleys, and a set of carriages. The set of carriages comprises a central carriage, a supporting carriage, and a basic structure, wherein the central carriage is connected to a functional component and is slidingly movably connected to the supporting carriage in the direction of the X-axis, wherein the supporting carriage is slidingly movably connected to the basic structure in the direction of the Y-axis (or vice versa, depending on the arrangement of the X- and Y-axes).

The first system of pulleys comprises a first driven disc and two discs of the supporting carriage attached to the supporting carriage on opposite sides of the supporting carriage, namely on opposite sides of the path of the central carriage on the supporting carriage, and the second system of pulleys comprises a second driven disc and two discs of the supporting carriage attached to the supporting carriage on opposite sides of the supporting carriage, namely on opposite sides of the path of the central carriage on the supporting carriage. The first belt is threaded through the first system of pulleys including the first driven disc, wherein by one side thereof it is threaded through the disc of the supporting carriage on the first side of the supporting carriage and attached to the central carriage by the respective end, and by other side thereof it is threaded through the disc of the supporting carriage on the other side of the supporting carriage and attached to the central carriage by the respective end. The second belt is threaded through the second system of pulleys including the second driven disc, wherein by one side thereof it is threaded through the disc of the supporting carriage on the first side of the supporting carriage and attached to the central carriage by the respective end, and by other side thereof it is threaded through the disc of the supporting carriage on the other side of the supporting carriage and attached to the central carriage by the respective end. Further, the first system of pulleys and the second system of pulleys each comprises at least one additional disc attached to the basic structure. As a standard, the first system of pulleys and the second system of pulleys both comprise at least four discs total (including the driven disc and the two discs of the supporting carriage). Preferably, the point of crossing of the first and second belts is moved outside the area of motion of the central carriage, wherein this modification requires the implementation of at least one additional stationary disc in both systems of pulleys. Preferably, therefore, the first system of pulleys and the second system of pulleys both comprise at least five discs total. A stationary disc means a disc that is not attached to any movable component within the CoreXY motion system, wherein it is connected to the basic structure.

The features mentioned in the previous paragraph are common to all CoreXY systems. The specific arrangement of the first system of pulleys and the second system of pulleys may then be different. However, the way in which its pulley systems work together using the first driven disc and the second driven disc is common to all the variants of the CoreXY motion system. The principle of the function of the CoreXY kinematic system will be explained using a scheme of the top view of a square area defining the motion of the central carriage, where the X-axis has a left-to-right direction and the Y-axis has a bottom-to-up direction. This square area can therefore be divided into four quadrants: top left, top right, bottom left, bottom right.

If the first driven disc and the second driven disc move at the same clockwise speed, the central carriage moves to the left. If the first driven disc and the second driven disc move at the same counterclockwise speed, the central carriage moves to the right. If the first driven disc and the second driven disc move at the same speed in opposite directions, the central carriage moves up and down, wherein if the first driven disc moves counterclockwise and the second driven disc moves clockwise, the central carriage moves up, and if the first driven disc moves clockwise and the second driven disc moves counterclockwise, the central carriage moves down. If only the first driven disc moves clockwise, the central carriage moves diagonally in the direction from the top right quadrant to the bottom left quadrant. If only the first driven disc moves counterclockwise, the central carriage moves diagonally in the direction from the bottom left quadrant to the top right quadrant. If only the second driven disc moves clockwise, the central carriage moves diagonally in the direction from the bottom right quadrant to the top left quadrant. If only the second driven disc moves counterclockwise, the central carriage moves diagonally in the direction from the top left quadrant to the bottom right quadrant.

Mathematically, the principle of the function of the CoreXY system can be expressed by the following equations, which are based on the scheme established above:

$$Δ A = Δ X + Δ Y$$

$$Δ B = Δ X - Δ Y$$

where ΔA represents the rate of movement of the first belt when the first driven disc rotates counterclockwise, ΔB represents the rate of movement of the second belt when the second driven disc rotates counterclockwise, ΔX represents the change in the position of the central carriage along the X-axis from left to right, and ΔY represents the change in the position of the central carriage along the Y-axis from bottom to top.

Thus, for example, if the first driven disc is rotated counterclockwise so that the first belt moves 3 cm in the corresponding direction, the sum of the distance by which the central carriage moves along the X-axis in the left-to-right direction and the distance by which the central carriage moves along the Y-axis in the bottom-to-top direction will be equal to 3 cm. The ratio of the change in the position in the direction of the X-axis to the change in the position in the direction of the Y-axis depends on the form of the specific arrangement of the pulley system, wherein it is based on the ratio of the total range of motion of the central carriage in the X-axis to the total range of motion of the central carriage in the Y-axis.

The change in the position of the central carriage along the X-axis from left to right and the change in the position of the central carriage along the Y-axis from bottom to top are then expressed as follows:

$$Δ X = \frac{Δ A + Δ B}{2}$$

$$Δ Y = \frac{Δ A - Δ B}{2}$$

The CoreXY type motion system of the invention thus uses the first cable as the first belt and the second cable as the second belt, wherein the first system of pulleys comprises a disc comprising a first drum and the second system of pulleys comprises a disc comprising a second drum. The fastening of the cables in the first and second systems of pulleys is done by tensioning them against the respective system of pulleys and wrapping them around the respective drums that are part of both systems of pulleys.

An advantage of the CoreXY type motion system of the invention is that it provides the motion of the functional component on the central carriage in the horizontal plane which is mechanically optimized, minimizes vibrations in the system, and eliminates the influence of inaccuracies and clearances in the gears, thus ensuring perfectly accurate motion of the functional component on the central carriage even at higher speeds and sudden changes in direction. The solution of the invention further provides a good ratio between the external dimensions of the machine and the usable internal working volume of the machine and can be adapted economically for small devices as well as extremely large machines, for example for 3D printing of residential houses.

Preferably the first cable is attached to the first drum, wherein the first cable is wrapped around the first drum with at least one wrap on either side of the place of attachment to the first drum, the second cable is attached to the second drum, wherein the second cable is wrapped around the second drum with at least one wrap on either side of the place of attachment to the second drum. In this context, reference is always made to the position of the first system of pulleys or the second system of pulleys, where the given drum and the respective wound cable are in the zero position, which corresponds to a state approximately halfway between the two extremes of the winding, where the first extreme corresponds to a state where the cable is unwound on the first side of the drum and wound to a corresponding extent as far as the motion system will allow on the second side, and the second extreme corresponds to a state where the cable is unwound on the second side of the drum and wound to a corresponding extent as far as the motion system will allow on the first side.

Preferably, the first and second extremes of the winding of the cable on the respective drum correspond to states where the first and second cables are still wrapped around the respective drum with at least one full wrap on both sides from the place of fastening. In this way, the stability of the motion system of the invention is achieved in all positions of the central carriage.

The firm attachment of the cables in one place to the drum ensures complete elimination of clearance during back-and-forth motion. From this place of fixation, the cable is preferably wound in both directions with the same number of wraps

The cable can be connected to the drum in various ways, for example by a screw which fixes it in one place to the wall of the drum by its head, or the drum may comprise an opening in its wall wherein a part of the cable is placed in the opening where it is fixed. Alternatively, there may be two openings in the wall of the drum, wherein the cable is threaded into the drum through one opening and out through the other. Solutions where the cable is interrupted in the place of connection to the drum are also considered, for example both ends of the cable can enter the opening in the drum where they can be connected by a knot that is larger than the opening itself. In such cases, the first or second cable may be composed of two (or more) cables, wherein the first or second cable may be understood in this context to be a collection of cables that make up the cable.

In a preferred embodiment, the first driven disc comprises the first drum and the second driven disc comprises the second drum. A disc means a component that is rotationally attached to the set of carriages and which fulfills the function of a pulley for the respective cable. A drum means the cylindrical part of the disc that allows the cable to be wound. Since the drum represents the main fixation point of the cable within the given system of pulleys, it is advantageous for the overall structural stability if the entire system of pulleys is driven in this place.

The driven disc may be driven by a high-resolution electric stepper motor or servo motor or other motor providing sufficient accuracy. The driven disc can be driven by the motor directly through its axis or with a gear, but preferably using a clearance-free gearbox. In larger motion systems, it is advantageous to drive the driven disc with a servo motor or a stepper motor with a high number of steps (e.g. 10,000), wherein the motor is connected directly to the axis of the driven disc or via a clearance-free gearbox.

Preferably, the diameter of the discs and drums is adapted to the selected diameter, type, and material of the cable such that it does not wear and is not damaged due to breakage by too small a radius of the disc or drum. An example of a suitable combination is steel cables with a diameter of 1.6 mm and a diameter of the drums and discs of 80 mm.

Preferably, the first cable is tensioned against the first system of pulleys and the second cable is tensioned against the second system of pulleys. By sufficiently tensioning the cables, vibrations are minimized and clearances in the system are eliminated, even at higher speeds and sudden changes in the direction of the motion.

Preferably the first cable is wrapped around the first drum with a total of at least 4 wraps and/or the second cable is wrapped around the second drum with a total of at least 4 wraps. This achieves an even firmer attachment of the cable during operating cycles, but at the cost of a higher height of the drum to accommodate all the wraps of the cable during the operating cycle.

Preferably, the first cable, the second cable, the first system of pulleys and the second system of pulleys are formed from the same material. Thermal expansion plays a critical role in motion systems requiring precise motions, especially in applications where the system is at elevated temperatures or experiences significant changes in temperature during the operation of the system. The implementation of the cable allows the same material to be used for its structure as for most other components of the motion system, such as discs, carriages, linear guides, frames, etc. The currently used belts would be difficult to construct from similar materials to the rest of the motion system unless they were made as chains, but such a solution would introduce a significant amount of extra motion connections into the system that could contribute to deviations. The use of the same material for the construction of cables, carriage system, and discs minimizes the formation of deviations and clearances in the system due to different thermal expansion. The CoreXY type motion system enables normal operation in temperature conditions from 15 to 50° C. without measurable deviations and unwanted clearances in the system.

Preferably, the disc comprising the first drum is rotationally mounted by a screw with a thread pitch corresponding to the thickness of the first cable, and/or the disc comprising the second drum is rotationally mounted by a screw comprising a thread with a thread pitch corresponding to the thickness of the second cable. In this embodiment, the changes in the positions of the cables due to the rotation of the drums are compensated.

The principle of compensation will be explained using an embodiment where the cables are attached in a certain place to the drums and wound around the drums with four wraps in both directions from the place of fastening. In such a state of cable wrapping, the drum is exactly halfway between the two extremes of rotation of the cable, or is in the zero position. In the first extreme, the drum is rotated almost twice about its axis in one direction from the zero position, whereby the cable is unwound two wraps on one side from the place of fastening and wound to the corresponding extent on the other side from the place of fastening. In the second extreme, the drum is rotated almost twice about its axis in the opposite direction from the zero position, whereby the cable is wound with two wraps on one side from the place of fastening and unwound to the corresponding extent on the other side from the place of fastening. In such an embodiment, the cables are permanently wrapped with four wraps in the middle and only the external 4 wraps of the cable change, which is advantageous for a more stable fixation of the cable to the drum. In embodiments where the position of the drum does not change during its rotation, the heights of the two places where the cable leaves the drum, or the places where the cables are pulled out of the drum, change. This creates clearances and deviations in the system of pulleys, as the place where the cable leaves the drum changes between the two extremes above, namely it changes by a distance corresponding to twice the diameter of the cable, which also changes the length of the cable between the place where the cable leaves the drum and is adjacent to the next disc, which is mounted in a fixed way.

These changes in the position of the cable on the drum are compensated for by mounting the disc with the drum using a screw, where the drum moves on a helix during rotations, whose pitch corresponds to the thickness of the cable. So when the drum rotates in one direction, the two places where the cable leaves the drum move upward relative to the drum, but the drum moves downward along the helix by a corresponding distance relative to the rest of the system, and therefore from the point of view of the system the position of the cable does not change, only the relative position of the cable and the drum changes.

Preferably, the screw is a ball screw.

The first drum may comprise, in various embodiments, a first driven disc, a stationary disc, or a disc of the supporting carriage. The second drum may comprise, in various embodiments, a second driven disc, a stationary disc, or a disc of the supporting carriage.

### DESCRIPTION OF DRAWINGS

A summary of the invention is further clarified using exemplary embodiments thereof, which are described with reference to the accompanying drawings, in which:

FIG. 1 shows the CoreXY motion system of the first exemplary embodiment of the invention as viewed from above in a position of the central carriage at the bottom right,

FIG. 2 shows a T-T section of the CoreXY motion system of the first exemplary embodiment of the invention in a position of the central carriage at the bottom right,

FIG. 3 shows a detail Y of the first driven disc of the first exemplary embodiment of the invention in a position of the central carriage at the bottom right,

FIG. 4 shows a detail Z of the second driven disc of the first exemplary embodiment of the invention in a position of the central carriage at the bottom right,

FIG. 5 shows the CoreXY motion system of the first exemplary embodiment of the invention as viewed from above in a position of the central carriage in the middle,

FIG. 6 shows an S-S section of the CoreXY motion system of the first exemplary embodiment of the invention in a position of the central carriage in the middle,

FIG. 7 shows a detail W of the first driven disc of the first exemplary embodiment of the invention in a position of the central carriage in the middle,

FIG. 8 shows a detail X of the second driven disc of the first exemplary embodiment of the invention in a position of the central carriage in the middle,

FIG. 9 shows the CoreXY motion system of the first exemplary embodiment of the invention as viewed from above in a position of the central carriage at the top left,

FIG. 10 shows an R-R section of the CoreXY motion system of the first exemplary embodiment of the invention in a position of the central carriage at the top left,

FIG. 11 shows a detail U of the first driven disc of the first exemplary embodiment of the invention in a position of the central carriage at the top left,

FIG. 12 shows a detail V of the second driven disc of the first exemplary embodiment of the invention in a position of the central carriage at the top left,

FIG. 13 shows the CoreXY motion system of the second exemplary embodiment of the invention as viewed from above in a position of the central carriage at the bottom right,

FIG. 14 shows a C-C section of the CoreXY motion system of the second exemplary embodiment of the invention in a position of the central carriage at the bottom right,

FIG. 15 shows a detail H of the first driven disc of the second exemplary embodiment of the invention in a position of the central carriage at the bottom right,

FIG. 16 shows a detail I of the second driven disc of the second exemplary embodiment of the invention in a position of the central carriage at the bottom right,

FIG. 17 shows the CoreXY motion system of the second exemplary embodiment of the invention as viewed from above in a position of the central carriage in the middle,

FIG. 18 shows a B-B section of the CoreXY motion system of the second exemplary embodiment of the invention in a position of the central carriage in the middle,

FIG. 19 shows a detail F of the first driven disc of the second exemplary embodiment of the invention in a position of the central carriage in the middle,

FIG. 20 shows a detail G of the second driven disc of the second exemplary embodiment of the invention in a position of the central carriage in the middle,

FIG. 21 shows the CoreXY motion system of the second exemplary embodiment of the invention as viewed from above in a position of the central carriage at the top left,

FIG. 22 shows an A-A section of the CoreXY motion system of the second exemplary embodiment of the invention in a position of the central carriage at the top left,

FIG. 23 shows a detail D of the first driven disc of the second exemplary embodiment of the invention in a position of the central carriage at the top left,

FIG. 24 shows a detail E of the second driven disc of the second exemplary embodiment of the invention in a position of the central carriage at the top left,

FIG. 25 shows a perspective representation of the CoreXY motion system of the first exemplary embodiment of the invention in the context of the entire 3D printer, with the external structure of the 3D printer indicated and the Z-axis illustrated, including the print pad,

FIG. 26 shows a scheme of the arrangement of the pulley systems of the first and second exemplary embodiments of the invention,

FIG. 27 shows a scheme of the arrangement of the pulley systems of the CoreXY motion system of the third exemplary embodiment of the invention,

FIG. 28 shows a scheme of the arrangement of the pulley systems of the CoreXY motion system of the fourth exemplary embodiment of the invention,

FIG. 29 shows a scheme of the arrangement of the pulley systems of the CoreXY motion system of the fifth exemplary embodiment of the invention,

FIG. 30 shows a scheme of the arrangement of the pulley systems of the CoreXY motion system of the sixth exemplary embodiment of the invention,

FIG. 31 shows a scheme of the arrangement of the pulley systems of the CoreXY motion system of the seventh exemplary embodiment of the invention,

FIG. 32 shows a scheme of the arrangement of the pulley systems of the CoreXY motion system of the eighth exemplary embodiment of the invention,

FIG. 33 shows a detail of the first driven disc of the first exemplary embodiment in the middle position of the second drum with the top position of the drum and the bottom position of the drum indicated.

### EXEMPLARY EMBODIMENTS OF THE INVENTION

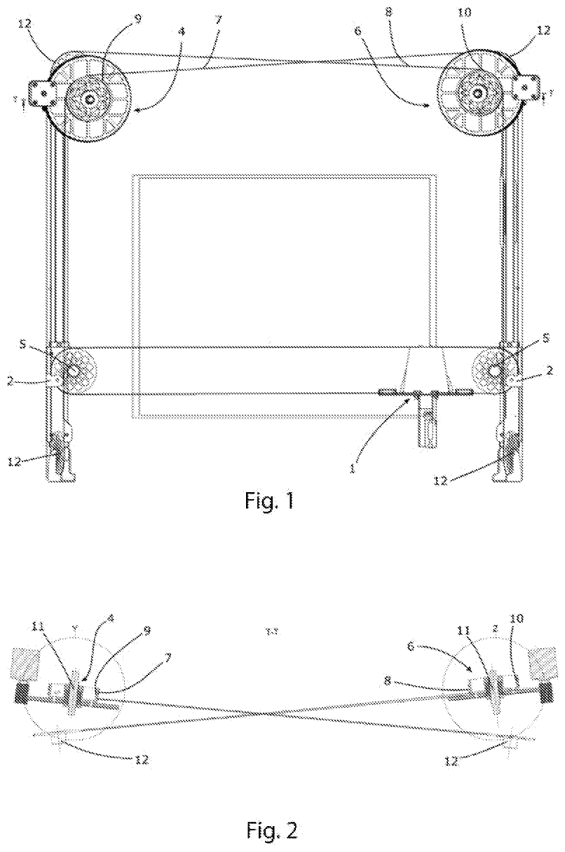

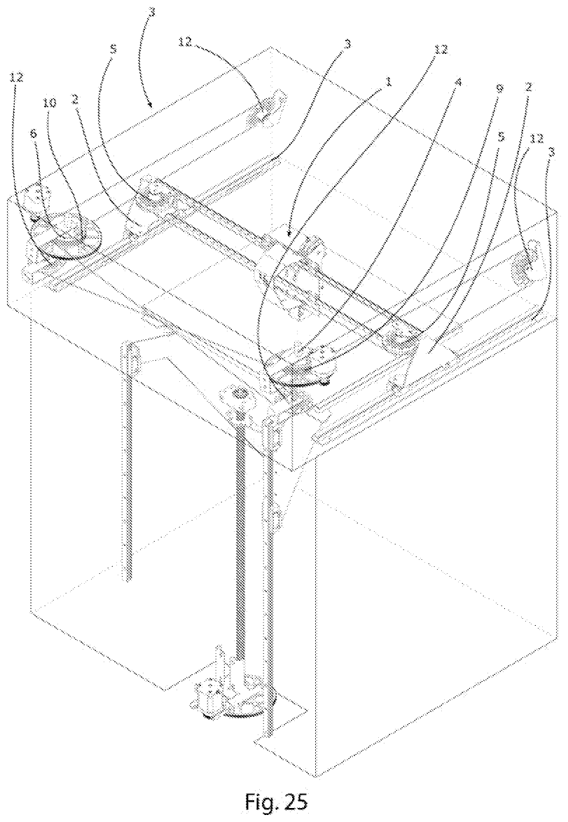

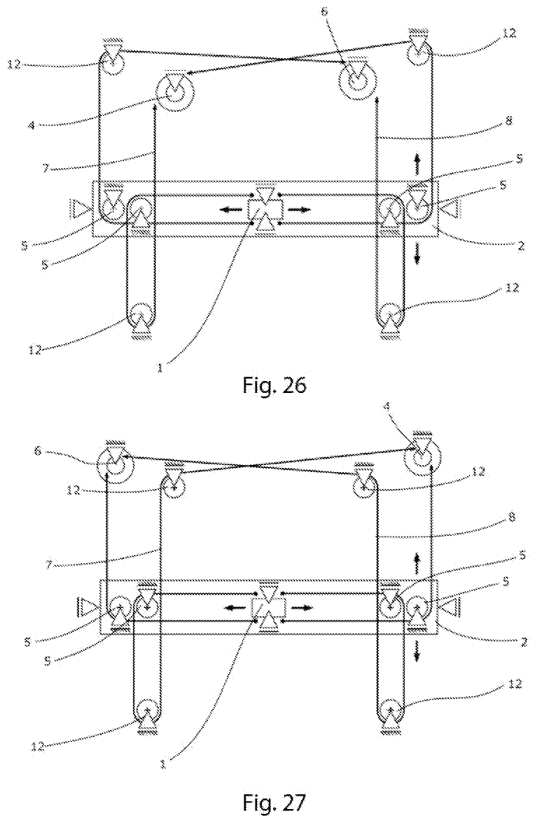

The CoreXY type motion system of the invention will be further clarified by way of exemplary embodiments with reference to the respective drawings. The first exemplary embodiment of the basic parts of the invention and its arrangement are illustrated in FIG. 1 to FIG. 12, FIGS. 25 and 26.

The CoreXY motion system of the first exemplary embodiment is a part of a 3D printer, where it forms a motion apparatus in the horizontal plane along the X- and Y-axes, wherein it comprises a first cable 7, a second cable 8, a first system of pulleys, a second system of pulleys, and a set of carriages. The set of carriages comprises a central carriage 1, a supporting carriage 2, and a basic structure 3, wherein the central carriage 1 is connected to the extruder of the 3D printer and is slidingly movably connected by two linear guides to the supporting carriage 2 in the direction of the X-axis. The supporting carriage 2 comprises a first side of the supporting carriage 2 and a second side of the supporting carriage 2 located on opposite sides of the linear guides of the supporting carriage 2 for moving the central carriage 1, the supporting carriage 2 is then slidingly movably connected on its first and second sides to the respective linear guides of the basic structure 3 in the direction of the Y-axis. The basic structure 3 is firmly connected to the supporting structure of the 3D printer, wherein the basic structure 3 forms attachment points for fastening the individual components of the motion system of the invention. The set of carriages and the pulley systems of the first exemplary embodiment allow the central carriage 1 to move over an area of 600 mm by 600 mm.

The first system of pulleys comprises a first driven disc 4, which is rotationally connected to the basic structure 3, thus is stationary, and comprises a first drum 9 with a diameter of 80 mm. The first driven disc 4 comprises a toothed ring with a diameter twice as large as the first drum 9. Adjacent to the toothing of the ring of the first driven disc 4 is a pinion of the stepper motor by which the first driven disc 4 is driven, where the pinion has a tooth height approximately five times greater than the tooth height of the toothing of the ring of the first driven disc 4, thereby ensuring that the first driven disc 4 does not pull out of the pinion of the motor during its motions in the direction of the axis of rotation. The pinion of the motor and toothed ring together form a clearance-free system of toothing. Further, the first system of pulleys comprises one disc 5 of the supporting carriage attached to the supporting carriage 2 on its first side and one disc 5 of the supporting carriage attached to the supporting carriage 2 on its second side, thus namely on opposite sides of the path of the central carriage 1 on the supporting carriage 2.

The second system of pulleys comprises a second driven disc 6, which is rotationally connected to the basic structure 3, thus is stationary, and comprises a second drum 10 with a diameter of 80 mm. The second driven disc 6 comprises a toothed ring with a diameter twice as large as the second drum 10. Adjacent to the toothing of the ring of the second driven disc 6 is a pinion of the stepper motor by which the second driven disc 6 is driven, where the pinion has a tooth height approximately five times greater than the tooth height of the toothing of the second driven disc 6, thereby ensuring that the second driven disc 6 does not pull out of the pinion of the motor during its motions in the direction of the axis of rotation. Further, the second system of pulleys comprises one disc 5 of the supporting carriage attached to the supporting carriage 2 on its first side and one disc 5 of the supporting carriage attached to the supporting carriage 2 on its second side, thus namely on opposite sides of the path of the central carriage 1 on the supporting carriage 2.

The two discs 5 of the supporting carriage on the first side of the supporting carriage 2 are combined into one double disc that comprises two separately rotationally movable discs 5 of the supporting carriage which share the axis of rotation. The two discs 5 of the supporting carriage on the second side of the supporting carriage 2 are also combined into one double disc that comprises two separately rotationally movable discs 5 of the supporting carriage which share the axis of rotation. This saves space within the system and at the same time, the supporting carriage 2 is structurally simplified.

Further, the first system of pulleys and the second system of pulleys each further comprise two stationary discs 12 attached to the basic structure 3.

The first cable 7 and the second cable 8 are made of steel and have a diameter of 1.6 mm. The first cable 7 is threaded through the first system of pulleys, wherein it is attached at one end to the central carriage 1, wound approximately with eight wraps around the first drum 9, and attached at its other end to the central carriage 1. The first cable 7 is attached to the first drum 9 in such a way that it is threaded through a hole in the wall of the first drum 9, and on the other side of the hole it is provided with a pin larger than the diameter of the hole, wherein by tensioning the cable 7 the pin is supported around the hole, thereby fastening the first cable Z to the first drum 9. The place of fastening of the first cable 7 corresponds to the place on the first drum 9 from which the first cable 7 is wound in both directions with the same number of wraps in the zero position of the first drum 9, i.e. in the position corresponding to the state halfway between the two extremes of the winding of the cable. Analogously, the second cable 8 in the second system of pulleys is threaded and fastened.

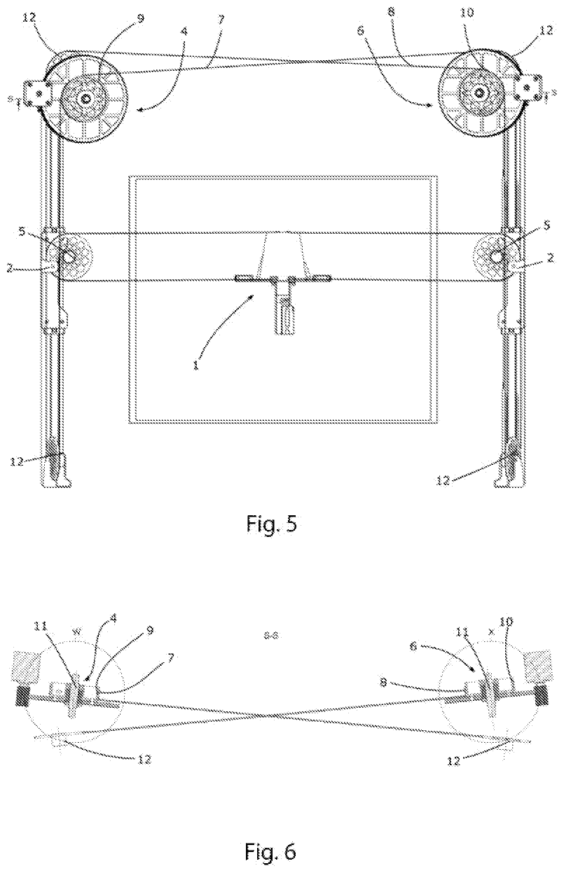

The specific arrangement of the discs forming the first and second systems of pulleys of the first exemplary embodiment of the invention is shown in the scheme of FIG. 26. This scheme corresponds to the real representation of FIG. 5. The system is shown viewed from above. In the scheme, it can be seen that the stationary discs 12 are placed in the corners of an imaginary square that defines the motion of the central carriage 1. In the first exemplary embodiment, the motion of the central carriage 1 is adapted to the print pad, which is movable along the vertical Z-axis, the entire 3D printer with a visible Z-axis comprising the CoreXY motion system of the first exemplary embodiment is shown in FIG. 25. The print pad is also indicated in the drawings of FIGS. 1, 5, and 9.

The first system of pulleys has one stationary disc 12 located in the bottom left corner and one stationary disc 12 in the top right corner, the first driven disc 4, which is also stationary, is located in the top left corner. The first cable Z is fastened by one end thereof to the central carriage 1 and then threaded through the disc of the supporting carriage 2 on the first side of the supporting carriage 2 such that it leads from it to the stationary disc 12 in the bottom left corner, around which it is wound such that it is rotated by 180° towards the first drum 9 of the first driven disc 4. From the first drum 9, it then leads to another stationary disc 12 in the top right corner, from which it leads to the disc 5 of the supporting carriage on the other side of the supporting carriage 2, from which it leads to the central carriage 1, to which it is also connected by the other end thereof.

The second system of pulleys has one stationary disc 12 located in the bottom right corner and one stationary disc 12 in the top left corner, the second driven disc 6, which is also stationary, is located in the top left corner. The second cable 8 is fastened by one end thereof to the central carriage 1 and then threaded through the disc 5 of the supporting carriage on the other side of the supporting carriage 5 such that it leads from it to the stationary disc 12 in the bottom right corner, around which it is wound such that it is rotated by 180° towards the second drum 10 of the second driven disc 6. From the second drum 10, it then leads to another stationary disc 12 in the top left corner, from which it leads to the disc 5 of the supporting carriage on the first side of the supporting carriage 2, from which it leads to the central carriage 1, to which it is also connected by the other end thereof.

The stationary discs 12 in the bottom left and bottom right corners are oriented vertically, wherein the first driven disc 4 and the second driven disc 6 are elevated relative to the discs 5 of the supporting carriages and the stationary discs 12 in the top left and top right corners of the system. As shown in FIGS. 2, 6 and 10, the first driven disc 4 and the second driven disc 6 are inclined such that they face the respective downstream stationary disc 12 located one level below, the latter being oriented in the same way as the respective driven disc 4,6.

The first cable Z is wound on the first drum 9 such that, on the top side, the first cable 7 leaves the first drum 9 towards the stationary disc 12 in the bottom left corner (vertically oriented) and, on the bottom side, the first cable 7 leaves the first drum 9 towards the stationary disc 12 in the top right corner (rotated and located below the level of the first driven disc 4).

The first driven disc 4 is rotationally mounted by a ball screw with a thread pitch corresponding to the thickness of the first cable 7, and the second driven disc 6 is rotationally mounted by a ball screw comprising a thread with a thread pitch corresponding to the thickness of the second cable 8. Thus, during the operation of the CoreXY motion system of the first exemplary embodiment, the first and second driven discs 4,6 move along the axis of their rotation in the opposite direction relative to the motion of the given cable 7,8 on the respective drum 9,10, by a distance corresponding to the thickness of the given cable 7,8 multiplied by the number of rotations of the given driven disc 4,6, thereby compensating for the elevation and lowering of the places where the cable leaves the given drum. Therefore, relative to the rest of the given system of pulleys, the cables 7,8 do not make unwanted motions that would cause clearances and deviations in the motion system.

The function of the CoreXY motion system of the first exemplary embodiment will be explained here. By means of the first driven disc 4 and the second driven disc 6, the central carriage 1 with the extruder is moved through the first system of pulleys and the second system of pulleys along the print area in the X- and Y-axes. The state of the motion system in 3 different positions of the central carriage 1 is described below.

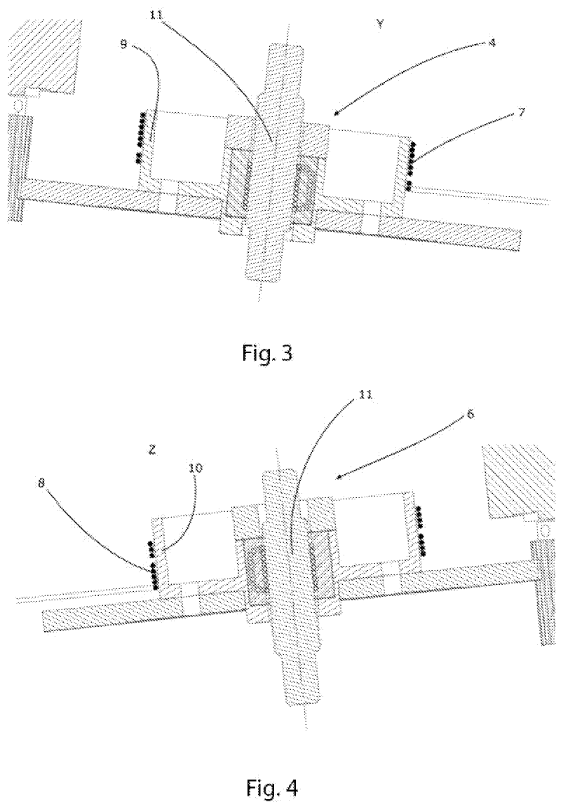

In FIGS. 1 to 4, the motion system of the first exemplary embodiment and selected components thereof are shown in the position of the central carriage 1 on the print pad at the bottom right when viewed from above. A view of the entire system from above is shown in FIG. 1. In the section of FIG. 2, it can be observed that the first cable 7 is unwound from the drum on the bottom side of the first drum 9, wherein it is located at a certain distance from the toothed ring. This elevation of the position of the places where the first cable Z leaves the first drum 9 is compensated by the downward movement of the first drum 9, as can be seen on the pinion of the motor, see FIGS. 2 and 3, the toothed ring of the first driven disc 4 is located on the bottom side thereof. In this position, in contrast, the second cable 8 is wound around the second drum 10 closer to the toothed ring of the second driven disc 6, wherein the toothed ring of the second driven disc 6 is located on the top side of the pinion of the motor, as can be seen in FIGS. 2 and 4.

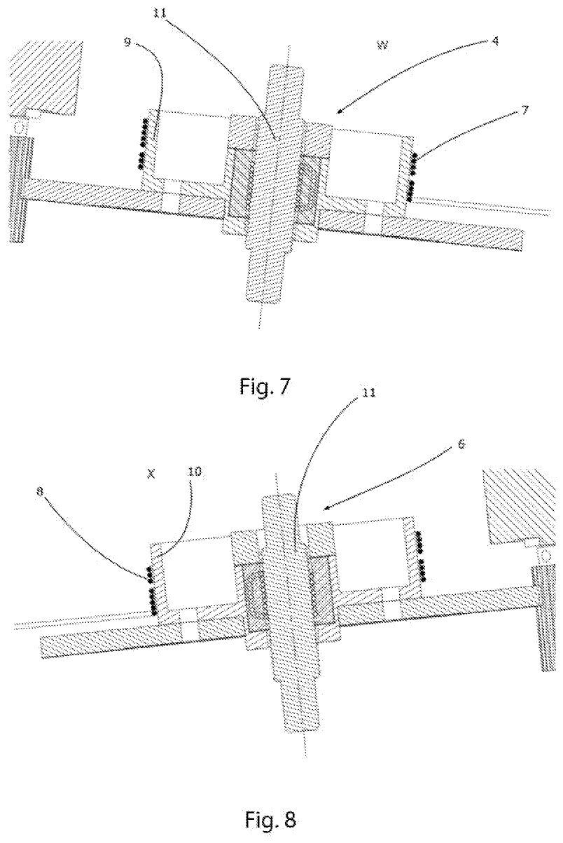

When the central carriage 1 moves to the middle of the print area, as shown in FIGS. 5 to 8, the first driven disc 4 is rotated such that the first cable 7 is unwound from the top side of the first drum 9 and wound more on the bottom side of the first drum 9. This motion of the first cable 7 is compensated by an upward movement of the first driven disc 4 in the direction of the axis of its rotation, which can be observed in FIG. 7, where a movement of the toothed ring of the first driven disc 4 to the middle of the height of the pinion of the motor can be seen. As can be seen in FIGS. 6 and 8. the state of winding of the second cable 8 and the position of the second driven disc 6 remain unchanged during this motion.

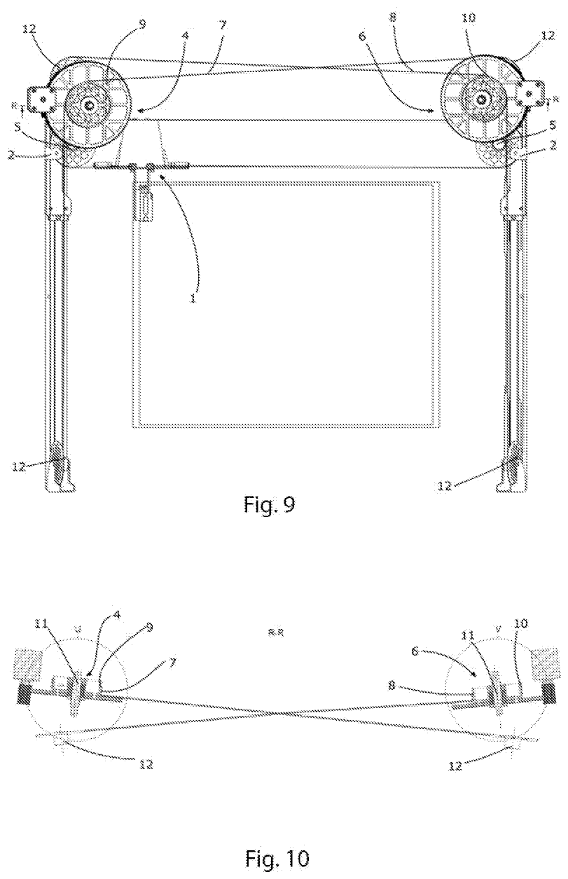

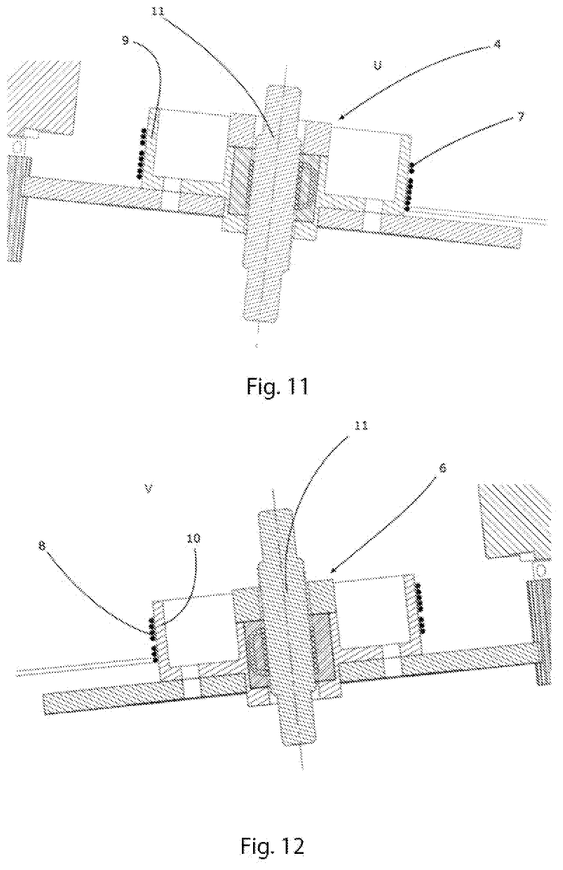

When the central carriage 1 is moved from the central position to the top left position when viewed from above on the print area, as shown in FIGS. 9 to 12, the first driven disc 4 is rotated such that the first cable Z is unwound from the top side of the first drum 9 even more and wound more on the bottom side of the first drum 9 almost to the toothed ring. This motion of the first cable 7 is compensated by a further upward movement of the first driven disc 4 in the direction of the axis of its rotation, which can be observed in FIG. 11, where the movement of the toothed ring of the first driven disc 4 to the top side of the pinion of the motor is visible. Compared to the previous position of the central carriage 1 in the middle of the print area, the second cable 8 is wound from the bottom side of the second drum 10 more on the top side thereof further away from the toothed ring, wherein this motion of the second cable 8 is compensated by the downward movement of the second driven disc 6 in the direction of the axis of its rotation, see FIG. 12.

In FIG. 33, the first driven disc 4 and the first drum 9 thereof of the first exemplary embodiment are shown in three different states according to the above presented positions of the central carriage 1. The top position 13 of the drum is occupied by the first drum 9 when the central carriage 1 is positioned at the top left when viewed from above. The middle position 14 of the drum is occupied by the first drum 9 when the central carriage 1 is positioned in the middle when viewed from above. The bottom position 15 of the drum is occupied by the first drum 9 when the central carriage 1 is positioned at the bottom right when viewed from above.

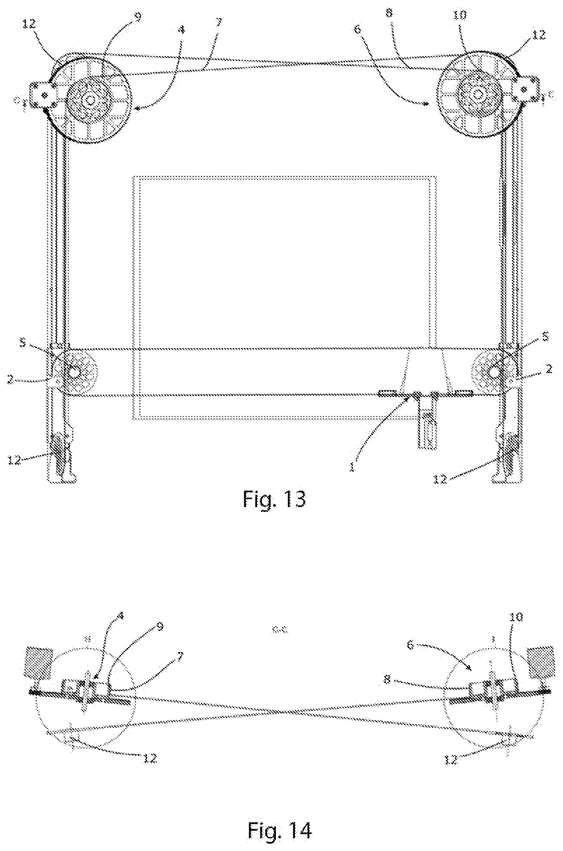

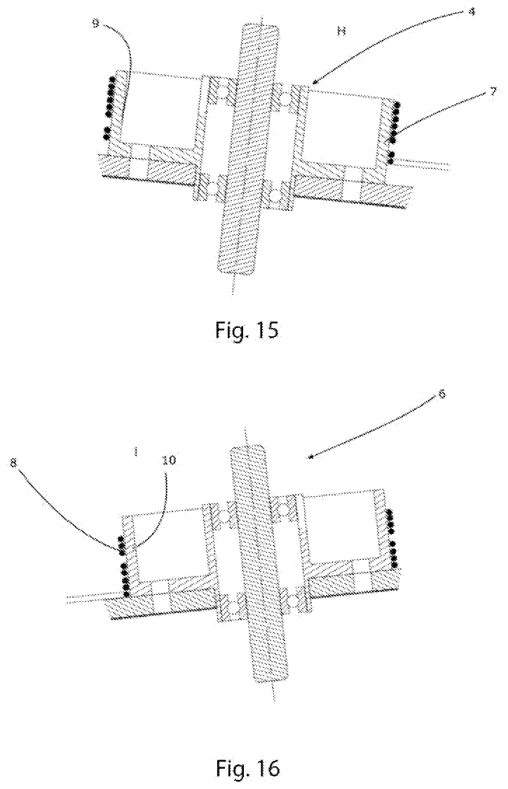

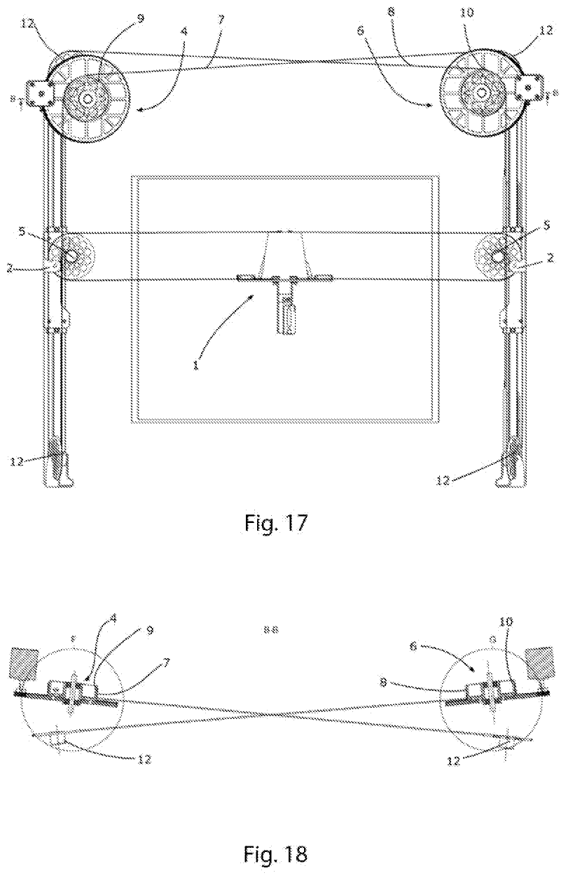

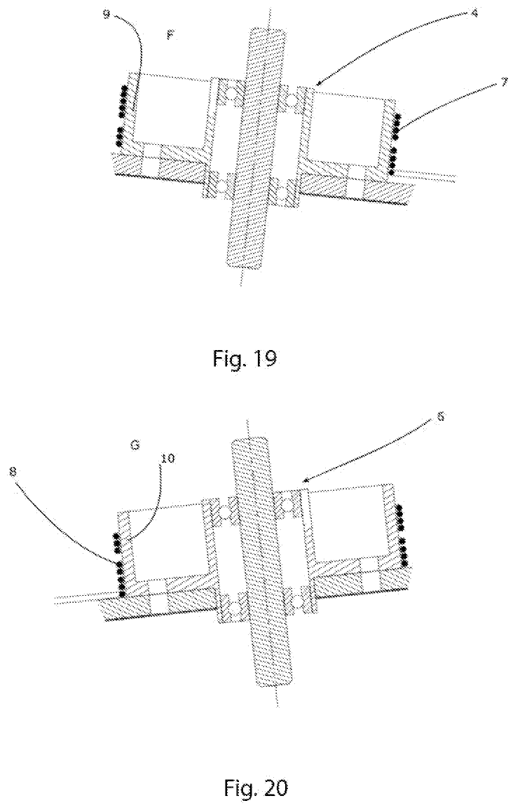

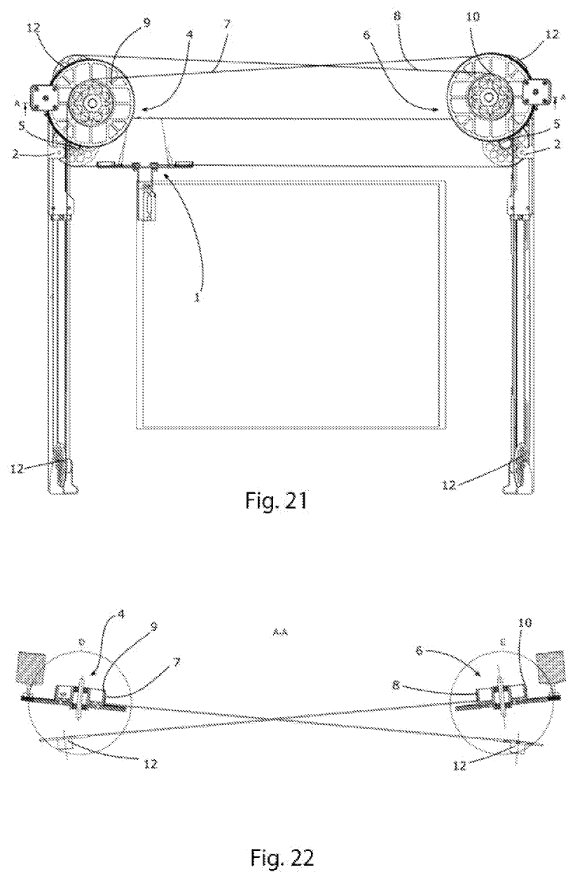

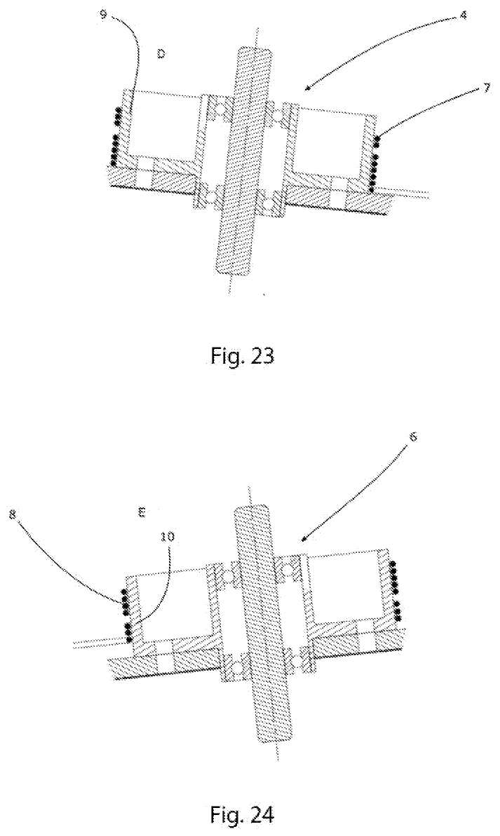

The second exemplary embodiment of the basic parts of the invention and its arrangement are shown in FIG. 13 to FIGS. 24 and 26. The second exemplary embodiment differs from the first exemplary invention in that the first and second driven discs 4,6 are only rotationally attached on the basic structure 3, wherein they are fixedly anchored against motion in the direction of the axis of their rotation, thereby preventing compensating motions in the direction of the axis of their rotation. A disadvantage of this embodiment is the change in the length of the first and second cables 7,8 between the respective driven discs 4,6 and the respective adjacent stationary discs 10, which is shown in FIGS. 14, 18, and 22. This is due to the change in the position of the places in which the first or second cable 4,6 leaves the respective drum 9,10. In the second exemplary embodiment, the resulting deviation reaches approximately the value 0.004 mm, which is manifested by a deviation in the motion of the central carriage 1 and a deformation of the printed lines of the extruder towards the center of the print area.

In various alternative embodiments of the invention, the driven discs 4,6 may be located in different places within the respective system of pulleys. The following exemplary embodiments are implemented according to the CoreXY motion system of the first exemplary embodiment of the invention, except for the different arrangements of the driven discs 4,6.

FIG. 27 shows a scheme of the arrangement of an alternative embodiment of the invention, where the driven discs 4,6 are located instead of the adjacent stationary discs 12 in the top left and right corners, and the stationary discs 12 are located in the original places of the driven discs 4,6 of the first exemplary embodiment, and are now above the level of the driven discs 4,6. This embodiment is advantageous if the center of gravity of the device needs to be lowered.

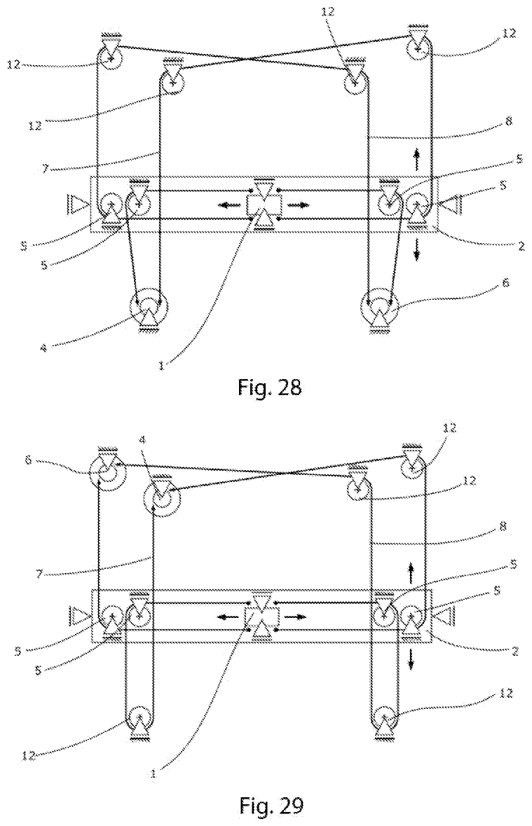

FIG. 28 shows a scheme of the arrangement of an alternative embodiment of the invention, where the driven discs 4,6 are located instead of the adjacent stationary discs 12 in the bottom left and right corners, and the stationary discs 12 are located in the original places of the driven discs 4,6. This embodiment is advantageous in embodiments where a bulkier embodiment of the driven discs 4,6 or drums 9,10 or drive motors is suitable, as this placement provides more space around them.

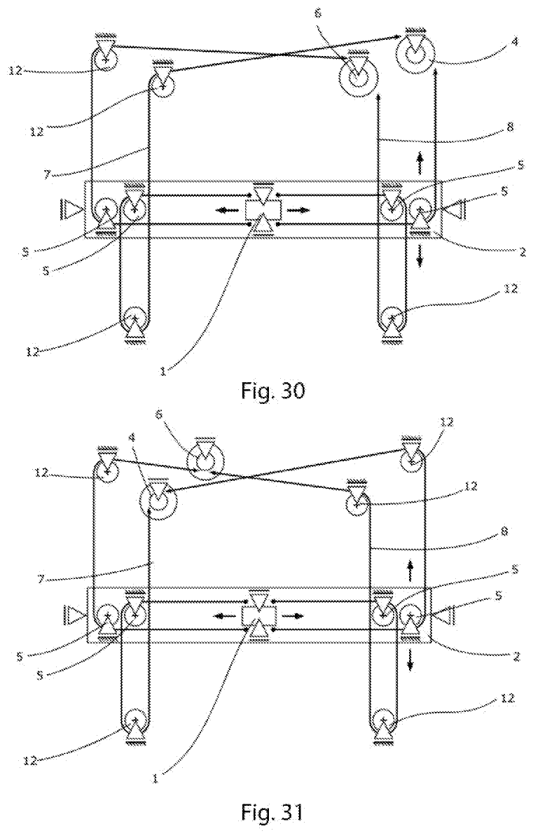

FIG. 29 shows a scheme of the arrangement of an alternative embodiment of the invention, where, in comparison with the arrangement of the first exemplary embodiment, the location of the second driven disc 6 is switched with its adjacent stationary disc 12 in the top left corner. This embodiment is advantageous in terms of concentrating the motors into one place. FIG. 30 shows a similar embodiment, but the driven discs 4,6 are located on the top right side.

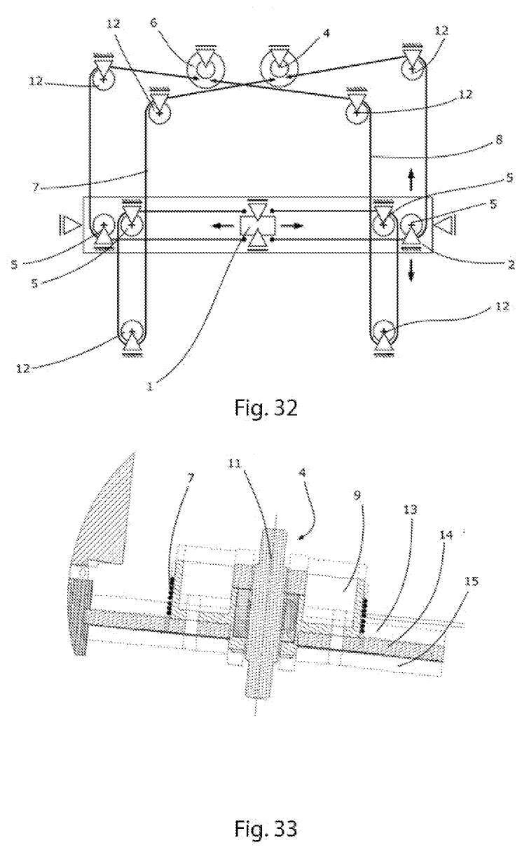

FIGS. 31 and 32 show embodiments with a larger total number of discs. FIG. 31 is an embodiment with one extra stationary disc 12, wherein the second driven disc 6 is located between two adjacent stationary discs 12, where the second cable 8 leaves the second drum 10 in the same direction from which it is wound thereto. FIG. 32 shows an embodiment with two extra stationary discs 12 compared to the first and second exemplary embodiments, wherein both driven discs 4,6 are located between two adjacent stationary discs 12 within the respective system of pulleys, wherein both the first and second cables 7,8 leave the respective drum 9,10 in the same direction from which they are wound thereto. These embodiments demonstrate that the driven discs 4,6, or drums 9,10, can be located in many other ways, provided that the motion system comprises discs according to the basic arrangement as defined by CoreXY in the Summary of the Invention above.

### INDUSTRIAL APPLICABILITY

The invention can be used within the motion systems of CNC machines, marking devices, lasers, light and large 3D milling machines, automatic assembly machines in the electrical industry, or any other machine that comprises a motion system that provides motion of a functional component in two mutually perpendicular axes.

### LIST OF REFERENCE SIGNS

1—Central carriage
2—Supporting carriage
3—Basic structure
4—First driven disc
5—Disc of the supporting carriage
6—Second driven disc
7—First cable
8—Second cable
9—First drum
10—Second drum
11—Screw
12—Stationary disc
13—Top position of the drum
14—Middle position of the drum
15—Bottom position of the drum

1. A CoreXY type motion system comprising a set of carriages, a first system of pulleys, and a second system of pulleys, wherein the set of carriages comprises a central carriage, a supporting carriage, and a basic structure, wherein the central carriage is slidingly movably connected to the supporting carriage in the direction of the X-axis and the supporting carriage is slidingly movably connected to the basic structure in the direction of the Y-axis perpendicular to the X-axis, the first system of pulleys comprises a first driven disc connected to the basic structure and two discs of the supporting carriage attached to opposite sides of the supporting carriage and the second system of pulleys comprising a second driven disc connected to the basic structure and two discs of the supporting carriage attached to opposite sides of the supporting carriage, a first cable and a second cable, the first system of pulleys comprises a disc comprising a first drum and the second system of pulleys comprises a disc comprising a second drum, wherein the first cable is pulled through the first system of pulleys, with its ends attached to the central carriage and wrapped around the first drum with at least two wraps, wherein the second cable is pulled through the second system of pulleys, with its ends attached to the central carriage, and wrapped around the second drum with at least two wraps.

2. The CoreXY type motion system according to claim 1, where the first cable is attached to the first drum, wherein the first cable is wrapped around the first drum with at least one wrap on either side of the place of attachment to the first drum, the second cable is attached to the second drum, wherein the second cable (8) is wrapped around the second drum with at least one wrap on either side of the place of attachment to the second drum.

3. The CoreXY type motion system according to claim 1, wherein the first driven disc comprises the first drum and the second driven disc comprises the second drum.

4. The CoreXY type motion system according to claim 1, wherein the first cable is tensioned relative to the first system of pulleys and the second cable is tensioned relative to the second system of pulleys.

5. The CoreXY type motion system according to claim 1, wherein the first cable is wrapped around the first drum with at least 4 wraps and/or the second cable is wrapped around the second drum with at least four wraps.

6. The CoreXY type motion system according to claim 1, wherein the first cable, the second cable, the first system of pulleys and the second system of pulleys are formed of the same material.

7. The CoreXY type motion system according to claim 1, wherein the disc comprising the first drum is rotationally mounted by a screw with a thread pitch corresponding to the thickness of the first cable, and/or the disc comprising the second drum is rotationally mounted by a screw comprising a thread with a thread pitch corresponding to the thickness of the second cable.

8. The CoreXY type motion system according to claim 7, wherein the screw is a ball screw.
